(19) United States
(12) Patent Application Publication
(10) Pub. No.: US 2025/0260028 A1
(43) Pub. Date: Aug. 14, 2025

(54) COMPRESSION SYSTEM WITH GAS LEAK RECOVERY AND FUEL CELLS, AND METHOD

(71) Applicant: NUOVO PIGNONE TECNOLOGIE - S.R.L., Florence (IT)

(72) Inventor: Luca PETRUZZI, Florence (IT)

(21) Appl. No.: 18/849,319

(22) PCT Filed: Mar. 24, 2023
(86) PCT No.: PCT/EP2023/025135

§ 371 Date: Sep. 20, 2024

(30) Foreign Application Priority Data
Mar. 25, 2022 (IT) 102022000005948
Feb. 28, 2023 (IT) 102023000003600

(51) Int. Cl. H01M 8/04089; F04B 53/14; H01M 8/04007; H01M 8/04111; H01M 8/0438; H01M 8/04537; H01M 8/0612

(52) U.S. Cl. CPC H01M 8/04097; F04B 53/144; H01M 8/04059; H01M 8/04111; H01M 8/04388; H01M 8/04604; H01M 8/0612

(57) ABSTRACT

A compression system comprising a compressor, the compressor comprising a sealing arrangement including at least one gas seal. A gas leakage recovery line is adapted to recover process gas leakages from the at least one gas seal. A fuel cell arrangement is fluidly coupled to the gas leakage recovery line. The fuel cell arrangement is adapted to process gas leakages and generate electric power therefrom.

### TECHNICAL FIELD

The present disclosure concerns compression systems for processing gas, such as (but not exclusively) hydrogen. Embodiments disclosed herein specifically concern compression systems with gas leakage recovery.

### Background Art

When a gas is processed in a compressor, gas leakages through a sealing arrangement cannot be entirely avoided. An amount of process gas inevitably leaks through the seals around the rotary shaft of a dynamic compressor (e.g. a centrifugal compressor or an axial compressor) or through seal packing arranged around a piston rod in reciprocating compressors.

In some cases, the gas leakages are recovered and combusted in a flare, to prevent dispersion in the environment. This typically occurs if the process gas is a hydrocarbon, such as methane. In some cases, gas leakages are recovered and recy-cled towards the compressor suction side, to prevent loss of valuable gas.

When the process gas is hydrogen, such as in green-ammonia production plants or refinery processes, hydrogen leaking through the compressor seals is discharged in the atmosphere, as hydrogen does not have adverse effects on the environment. Even though this does not raise concerns from the point of view of envi-ronmental impact, nevertheless discharging hydrogen in the atmosphere represents a significant loss in terms of money and energy, considering the amount of power required to produce hydrogen from other fluids, e.g. from water through electrolysis.

It would therefore be beneficial to provide more efficient measures to prevent or reduce discharge of valuable process gas in the environment or combustion thereof in a flare.

### SUMMARY

According to an aspect, disclosed herein is a compression system including a compressor comprising a sealing arrangement including at least one gas seal. A gas leakage recovery line is adapted to recover process gas leakages from the at least one gas seal and a fuel cell arrangement is fluidly coupled to the gas leakage recovery line and is adapted to process recovered process gas leakages and generate electric power therefrom.

Hydrogen, or other valuable process gas leaking from the seals is recovered and used as fuel in the fuel cells to generate electric power. The compression system of the present disclosure is particularly advantageous when the process gas is hydrogen. In such case, while according to the current art the hydrogen leaking from the compressor is discharged in the environment, in the novel system disclosed herein, the hydrogen is directly used as a fuel for the fuel cell arrangement. Similar ad-vantages are achieved also when an inert gas is contained in the leakages, such as nitrogen, which is often used as a separation gas.

According to another aspect, disclosed herein is a method of operating a gas compression system; the method comprising the following steps: compressing the process gas in a compressor comprising a sealing arrangement; recovering process gas leakages from the sealing arrangement; delivering the recovered process gas leakages towards a fuel cell arrangement; and generating electric power in the fuel cell arrangement using the recovered process gas leakages.

Further features and embodiments of the compression system and of the method according to the present disclosure are described in the following description, reference being made to the enclosed drawings, and are set forth in the attached claims.

### BRIEF DESCRIPTION OF THE DRAWINGS

Reference is now made briefly to the accompanying drawings, in which:

FIG. 1 is a schematic of an embodiment of a system according to the present disclosure;

FIG. 2 is a schematic of a further embodiment of a system according to the present disclosure;

FIG. 3 is a schematic of a yet further embodiment of a system according to the present disclosure;

FIGS. 4 and 5 show flowcharts summarizing embodiments of methods according to the present disclosure; and

FIG. 6 is a schematic of a yet further embodiment of the system according to the present disclosure.

### DETAILED DESCRIPTION

In short, to enhance the energetic efficiency of a compression system, process gas leaking from the compressor seals is recovered and used, as such, or after conversion, in a fuel cell arrangement to generate electric power. If the process gas contains hydrogen, this latter can be used directly as a fuel in the fuel cells. Chemical energy contained in the hydrogen is converted into heat and electric energy that is made available for driving the compressor, or delivered to local utilities or to an electric power distribution grid. Valuable process gas, such as hydrogen, leaking from the compressor is used to generate useful power, thus increasing the energetic efficiency of the compression system.

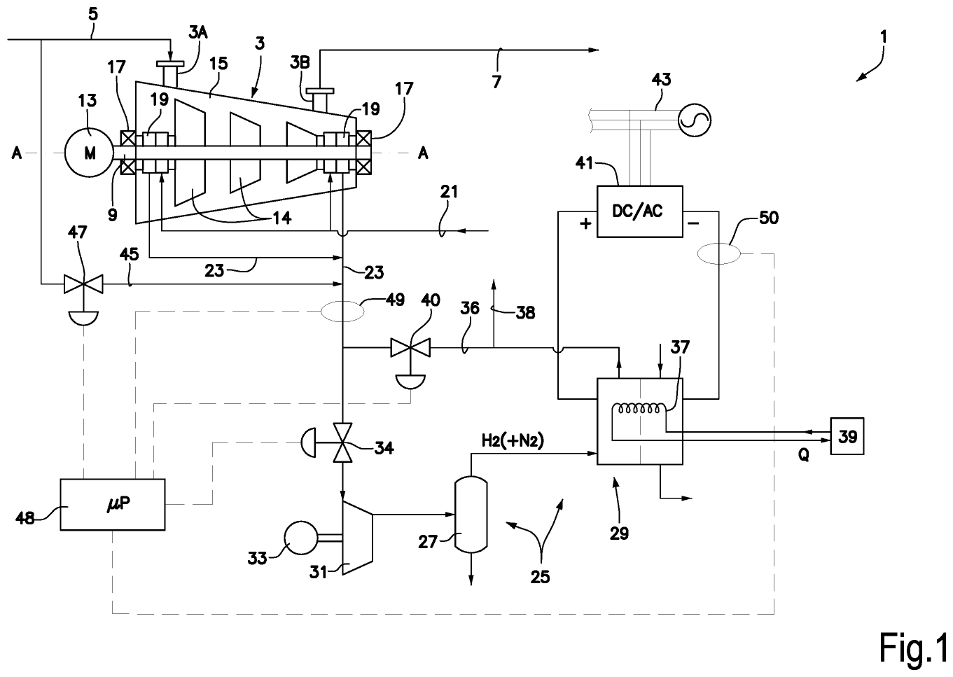

Turning now to the drawings, FIG. 1 illustrates a schematic of a first compression arrangement 1 according to the present disclosure. The system 1 includes at least one compressor 3, with a suction side3A and a delivery side 3B. Process gas is fed to the suction side 3A of the compressor 3 through an inlet line 5 and delivered from the delivery side 3B through an outlet line 7.

In the embodiment of FIG. 1, the compressor 3 is a centrifugal compressor including a rotor with a rotary shaft 9 and a plurality of impellers 11, which rotate around a rotation axis A-A. The compressor 3 can be driven by a driver 13, such as an electric motor. In other embodiment the driver 13 may be a gas turbine engine or a steam turbine.

The rotary shaft 9 is supported in a casing 15 by bearings 17. A sealing arrangement seals the rotary shaft to prevent or reduce process gas leakages along the rotary shaft 9 towards the bearings 17 and therefrom into the environment. In the embodiment of FIG. 1 the sealing arrangement includes rotary seals 19 at both ends of the shaft 9. In some embodiments, the seals 19 can be dry gas seals supplied with separation gas, e.g. nitrogen, through a separation gas supply line 21.

The seals 19 are fluidly coupled to a gas leakage recovery line 23 adapted to collect process gas leaking from the seals 19. If separation gas is supplied to the seals 19, a blend of leaking process gas and separation gas is collected through the gas leakage recovery line 23.

The gas leakage recovery line 23 fluidly couples the seals 19 to a fuel cell arrangement 25, adapted to use the process gas leaking from the compressor 3 to produce electric power. The fuel cell arrangement 25 may include a cleaning system 27, adapted to remove oil and/or other contaminants contained in the gas flow collected by the gas leakage recovery line 23 prior to reaching the fuel cells 29. In some embodiments a booster compressor 31 can be provided along the gas leakage recovery line 23 to deliver the recovered gas leakages at the required pressure to the fuel cells 29. Reference 33 indicates a driver for the booster compressor 31. In some embodiments, a control valve 34 along the gas leakage recovery line 23 can be used to close the gas leakage recovery line 23 if needed, for instance when the fuel cell arrangement 25 is unavailable. A gas leakage discharge line 36 fluidly coupled to a flare or vent 38 can be selectively opened by a control valve 40, when the fuel cell arrangement 25 is unavailable.

The fuel cells 29 can include any kind of fuel cell adapted to convert chemical energy of the fuel and an oxidizing agent into electricity through a pair of redox reactions. The fuel cells 29 can be selected based on the nature of the process gas and separation gas, if any, delivered from the compressor 3 to the fuel cell arrangement 25.

Typically, the gas processed by the compressor 3 comprises hydrogen and the separation gas comprises nitrogen. High-temperature fuel cells, such as solid oxide fuel cells, can be used to generate electricity through the following reactions:

2H₂+2O²⁻→2H₂O+4e⁻ anode reaction

O₂+4e⁻→2O²⁻ cathode reaction:

2H₂+O₂→2H₂O overall reaction:

The oxidizer can be oxygen or a gaseous blend containing oxygen, such as air. Inert separation gas (such as nitrogen) as well as inert components contained in the air used as oxidizer source are present in the gaseous stream flowing through the fuel cells, but do not interfere with the above chemical reaction.

A variety of fuel cells can be used in the fuel cell arrangement 25, based on the composition of the leaking gas, on the flow rate as well as on other parameters of the system. By way of non-limiting examples, the following kinds of fuel cells can be mentioned: metal hydride fuel cells, electro-galvanic fuel cells, direct formic acid fuel cells (DFAFC), zinc-air battery, microbial fuel cells, up-flow microbial fuel cell (UMFC), regenerative fuel cells, direct borohydride fuel cells, alkaline fuel cells, direct methanol fuel cells, reformed methanol fuel cells, direct-ethanol fuel cells, proton-exchange membrane fuel cells, redox fuel cells (RFC), phosphoric acid fuel cells, solid acid fuel cells, molten carbonate fuel cells, solid oxide fuel cells (TOFC), protonic ceramic fuel cells, direct carbon fuel cells, planar solid oxide fuel cell, enzymatic biofuel cells, magnesium-air fuel cells.

In some embodiments, the fuel cell arrangement 25 may be further improved by providing a heat exchanger 37, adapted to recover heat from the fuel cells 29 and deliver the recovered thermal energy Q to a utility, schematically shown at 39.

While in FIG. 1 a single compressor 3 is shown in combination with the fuel cell arrangement 25, it shall be understood that a plurality of compressors 3 can be fluidly coupled to the fuel cell arrangement 25, such that process gas leakages from the plurality of compressors are processed by the same fuel cell arrangement 25 to generate electric power.

Moreover, the leakage gas recovery system can be arranged in modules with the aim of increasing the system availability and managing the leakage flow variation due to sealing wear

The electric power generated by the fuel cells 29 is a DC voltage power and shall be converted into AC voltage power in a DC/AC converter 41. The AC voltage power from the DC/AC converter can be used to directly supply one or more electric motors or other ancillary devices or utilities of the compression system 1 and/or can be delivered to an electric power distribution grid 43 for distribution to other users.

In some embodiments, the compression system 1 can include a fuel gas integration line 45, adapted to supply an additional flow of process gas to the fuel cell arrangement 25, if the gas leakage collected by the gas leakage recover line 23 is insufficient to operate the fuel cell arrangement 25, for instance. The fuel gas integration line 45 can be fluidly coupled to the inlet line 5, to the outlet line 7 or to an intermediate compressor stage of compressor 3, for instance. In the schematic of FIG. 1 the fuel gas integration line 45 is fluidly coupled to the inlet line 5 of the compressor 3.

A control valve 47 can be provided to control the flowrate of process gas supplied through the fuel gas integration line 45 to the fuel cell arrangement 25. In some embodiments, the control valve 47 can be functionally coupled to a control unit 48, which is further functionally coupled to the control valves 34 and 40, mentioned above.

The control unit 48 can be adapted to detect one or more parameters useful to control the amount of process gas required through the fuel gas integration line 45. For instance, the control unit 48 can be functionally coupled to a flowmeter 49 adapted to detect the flowrate of the process gas leakages collected through the gas leakage recovery line 23 and can be configured to modulate a flow of additional process gas towards the fuel cell arrangement 25. The control unit 48 can also be functionally coupled to the fuel cell arrangement 25 and control operation thereof. The control such as to bypass the fuel cell arrangement 25 by closing control valve 34 and opening control valve 40, in case of fuel cell unavailability, for instance. This allows continuous operation of the compression system 1 also in case of temporary shutdown of the fuel cell arrangement 25.

In some embodiments, the control unit 48 can also be functionally coupled to an electric current sensor 50, or to an additional sensor arrangement which can be adapted to detect the amount of DC current generated by the fuel cell arrangement 25, the voltage/current characteristic curve of the fuel cell arrangement 25 or other parameters. In other embodiments, the electric current sensor 50 can be arranged on the AC current line, and detect the AC current from the DC/AC converter.

Thus, the control unit 48 can be adapted to provide information/monitoring on the amount of electric power generated by the fuel cell arrangement 35, and/or to issue an alert if the electricity generated by the fuel cell arrangement 25 is higher than a threshold. Since the amount of electric power generated by the fuel cell arrangement 25 is a function of the gas leakage flowrate, high electric power values may be indicative of a failure or excessive wear of the sealing arrangement. Seal wear/failure monitoring and detection can be furtherly managed by an integrated control of the FC operating voltage/current characteristic curve versus the expected seal leakage.

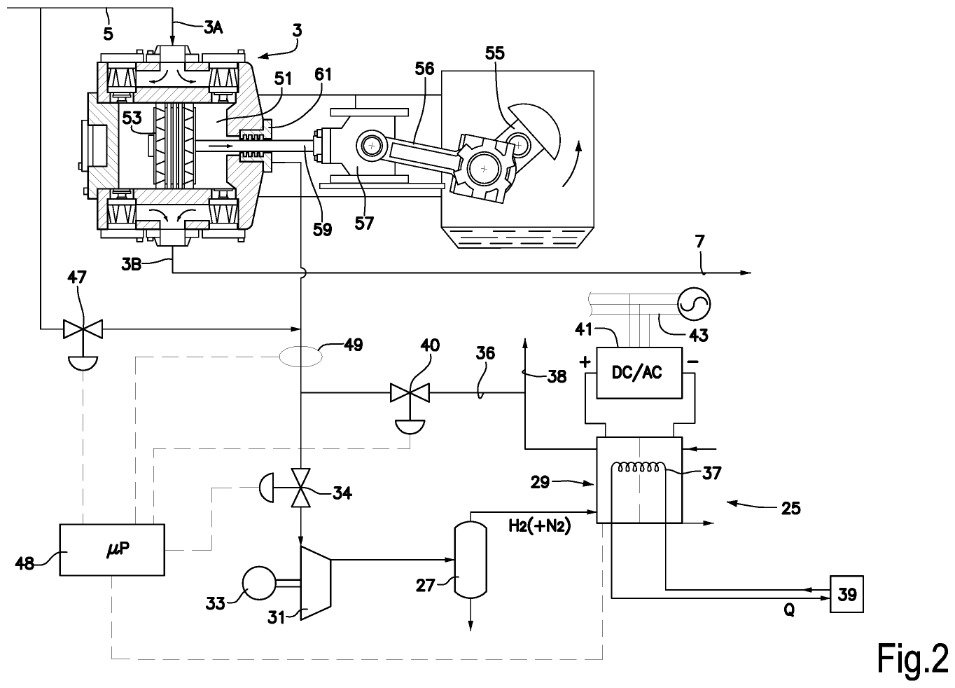

With continuing reference to FIG. 1, FIG. 2 illustrates a further embodiment of a compression system 1 of the present disclosure. The same reference numbers designate the same or similar components and parts of the system, which will not be described again. The compression system 1 of FIG. 2 differs from and the compression system 1 of FIG. 1 mainly in that the compressor 3 is a positive displacement compressor, such as a reciprocating compressor, rather than a dynamic (e.g. centrifugal) compressor.

The reciprocating compressor 1 of FIG. 2 includes a cylinder 51 housing a piston 53 reciprocating in the cylinder 51. The piston 53 is drivingly coupled to a crankshaft 55 through a connecting rod 56, a cross-head 57 and a piston rod 59. A gas sealing arrangement, including a gas seal packing 61, seals the cylinder 51 and reduces the process gas leaking from the reciprocating compressor.

The gas leakage recovery line 23 collects process gas leaking through the gas seal packing 61 and delivers the recovered process gas leakages to the fuel cell arrangement 25.

In some embodiments, reciprocating compressor(s) and dynamic compressor(s) can be used in combination in the same compression system.

Since fuel cells usually use hydrogen as a fuel gas, the above described arrangements are particularly beneficial in combination with compression systems wherein the process gas is hydrogen or a gaseous blend containing hydrogen. Typically, a centrifugal hydrogen compressor may have a hydrogen leaking rate between 0.5 and 5 kg/h through the rotary seals around the compressor shaft. Hydrogen leaking rate in an individual reciprocating compressor may range between 5 and 50 kg/h. Recovering the hydrogen leakages may lead to potential recoverable electric power in the range of 10-100 kWe for a centrifugal compressor and 100-1000 kWe for a reciprocating compressor.

As noted, fuel cells normally use hydrogen as a fuel gas and therefore a combination of fuel cells with a hydrogen compressor is particularly beneficial, since process gas leaking from the compressor can be used directly as fuel gas in the fuel cell arrangement.

However, the fuel cells to recover energy from recovered leakages of process gas can be used also in cases where the process gas is not directly usable as fuel in a fuel cell arrangement. In such circumstances, the leaking process gas can be converted in a conversion unit into a usable fuel gas for a fuel cell arrangement, in particular a gaseous mixture containing hydrogen. In some embodiments the conversion can be integrated in the fuel cell.

For instance, if the process gas is a hydrocarbon (CxHy), such as methane (CH₄), the leaking process gas can be at least partly converted into hydrogen, e.g. by steam reforming, water/gas shift, partial oxidation or any other suitable conversion process.

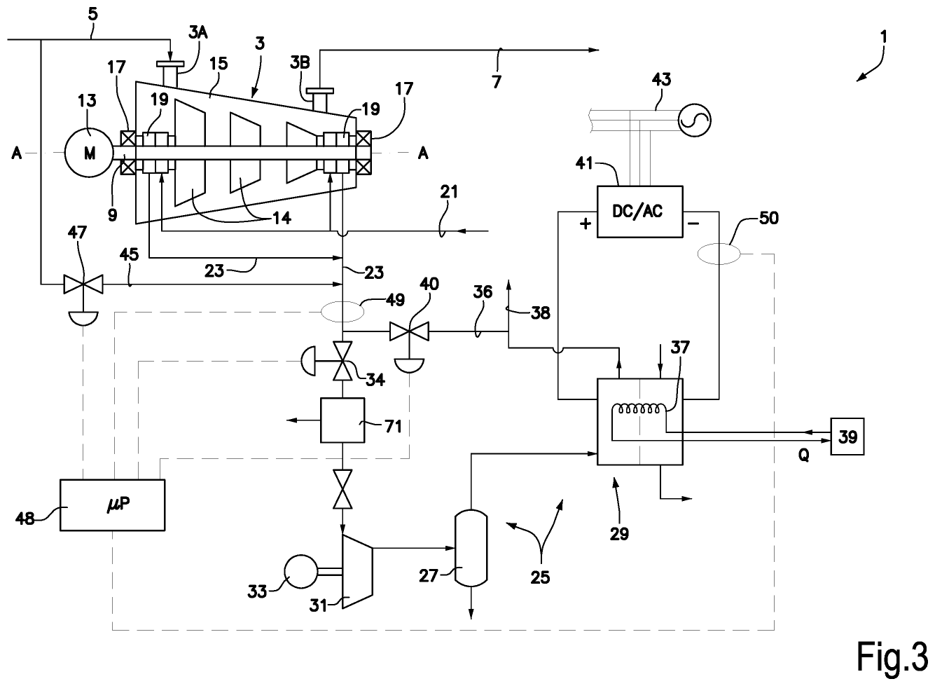

By way of example, FIG. 3 illustrates a schematic of an embodiment of a compression system 1 similar to the system of FIG. 1 or 2. The same reference numbers indicate the same components and parts of the system of FIG. 1, which will not be described again.

The system 1 of FIG. 3 differs from the system of FIGS. 1 and 2 mainly in that a conversion unit 71 is arranged along the gas leakage recovery line 23. The compressor 3 (which in FIG. 3 is illustrated as a centrifugal compressor, but which may be a reciprocating compressor, as shown in FIG. 2) may process methane or another hydrocarbon or a blend of hydrocarbons. The conversion unit 71 is adapted to at least partly convert the process gas leaking from the compressor 3 into hydrogen or a blend containing hydrogen, or in general in a gaseous species adapted to be used as fuel in the fuel cell arrangement 25.

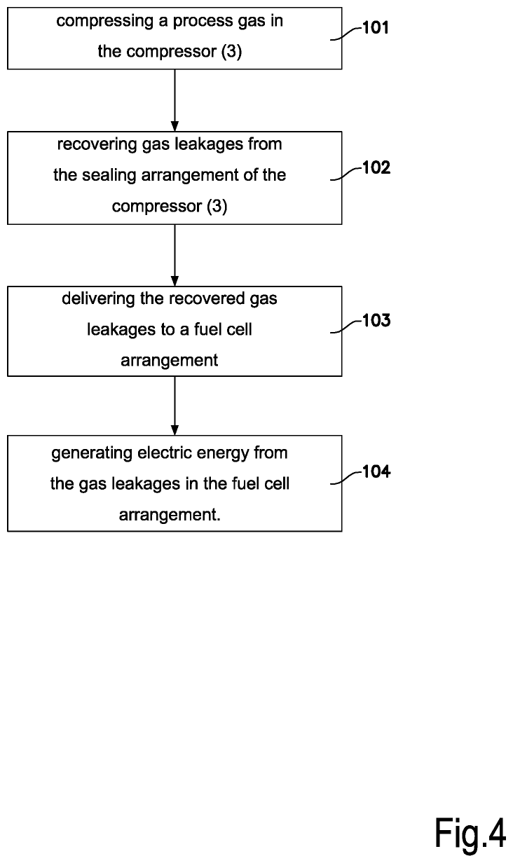

FIG. 4 illustrates a flowchart summarizing a method of operating a compression system 1 according to the present disclosure. The flowchart of FIG. 4 shows a method wherein the recovered process gas leakage is used directly as fuel gas in the fuel cell arrangement 25. The method includes the following steps: compressing a process gas in the compressor (step 101); recovering gas leakages from the sealing arrangement of the compressor 3 (step 102); delivering the recovered gas leakages to the fuel cell arrangement 25 (step 103); generating electric energy from the gas leakages in the fuel cell arrangement 25 (step 104).

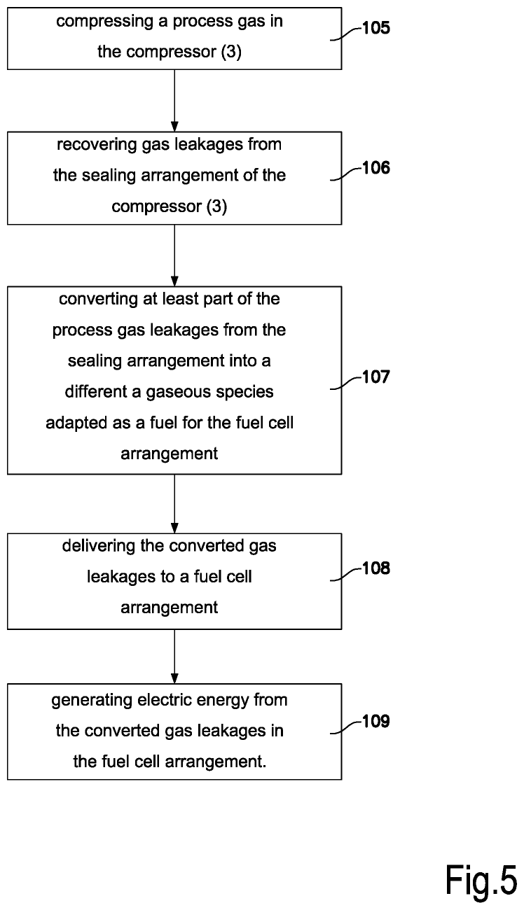

FIG. 5 shows a flowchart of a similar method, wherein the gas processed by the compressor 3 does not contain hydrogen, and is at least partly converted into a gaseous flow containing hydrogen and the converted gaseous flow is then delivered as fuel gas to the fuel cell arrangement. The method of FIG. 5 includes the following steps: compressing a process gas in the compressor 3 (step 105); recovering gas leakages from the sealing arrangement of the compressor 3 (step 106); chemically converting at least part of the process gas leakages from the sealing arrangement into a different a gaseous species adapted as a fuel for the fuel cell arrangement (step 107); delivering the converted gas leakages to a fuel cell arrangement (step 108); and finally generating electric energy from the converted gas leakages in the fuel cell arrangement 25 (step 109). Generally speaking, any process gas, which can be converted into hydrogen (in particular any hydrocarbon) can be used to recover electric power by adding a fuel processing system.

When separation gas, such as nitrogen, is used in the compressor seals, in order to maximize the fuel cell efficiency, a reduction of the separation gas in the hydrogen/separation gas recovered from the seals would be beneficial. In leakages from a centrifugal compressor the content of hydrogen ranges usually between 20 and 60%, while in reciprocating compressors the percentage of hydrogen is around 95% or higher, the rest being separation gas. To reduce the amount of separation gas in reciprocating compressors, control of the pressure in the separation gas buffering system and reduction of the separation gas leakages towards the crankcase can be foreseen. In centrifugal compressors, the leakages of separation gas can be minimized using abradable labyrinth seals, for instance.

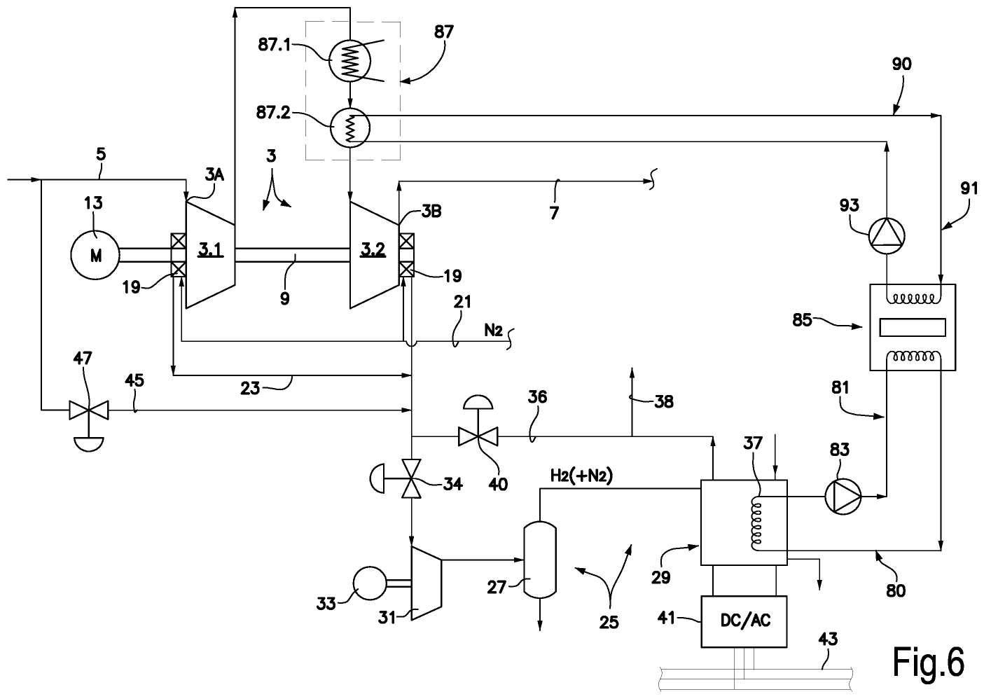

With continuing reference to FIGS. 1 to 5, a further embodiment of a system according to the present disclosure is shown in FIG. 6. The same reference numbers are used in FIG. 6 to designate the same or corresponding elements shown in FIGS. 1 to 3, which will not be described in detail again.

The embodiment of FIG. 6 includes a heat transfer system, which removes waste heat generated by the fuel cell arrangement 29 and uses the waste heat to provide a cooling capacity, which is exploited to improve the efficiency of the compression and/or to reduce the number of required compression stages and the cost, size, and complexity of the compression system.

In the embodiment of FIG. 6, a heat transfer system 80 is provided, including a heat exchanger 37 combined with the fuel cell arrangement 29 to remove waste heat therefrom. The heat exchanger 37 is fluidly coupled to a first heat transfer loop 81 which may include a circulation pump 83. The first heat transfer loop 81 is adapted to transfer waste heat recovered from the fuel cell arrangement 29 to an absorption refrigeration cycle schematically shown at 85.

The cooling capacity of the absorption refrigeration cycle is used to increase the efficiency of the compressor 3. For instance, the cooling capacity of the absorption refrigeration cycle 85 can be used to reduce the temperature of the process gas upstream of the compressor 3, such that the density of the process gas is increased. Alternatively, or in combination, the cooling capacity can be used in an intercooler, i.e. in a heat exchanger which removes heat from the process gas between two sequential compression steps.

FIG. 6 shows a compressor 3 including a first compression unit 3.1 and a second compression unit 3.2 arranged sequentially along a flow path of the process gas. The discharge side of the first compression unit 3.1 is fluidly coupled with the suction side of the second compression unit 3.2. The compressor 3 is represented only schematically in FIG. 6 and can be any kind of compressor suitable for the specific use, depending upon the nature of the process gas, the flowrate, the compression ratio, and the like. For instance, the compressor 3 can be a dynamic compressor, such as a centrifugal compressor, or a positive displacement compressor, such as a reciprocating compressor. In FIG. 6 the compressor 3 is represented as including a first compression unit 3.1 and a second compression unit 3.2. The compressor 3 can be a centrifugal compressor with a first compressor section and a second compressor section, housed in the same casing, for instance, wherein the compressor sections feature the first compression unit and the second compression unit.

In other embodiments, the compressor 3 can include separate compressors connected in series and representing a first compression unit and a second compression unit.

In other embodiments, the compressor 3 can be a reciprocating compressor including two stages in series, featuring the first compression unit and the second compression unit.

Irrespective of the structure and nature of the compressor 3, an intercooler 87 is positioned between the first compression unit 3.1 and the second compression unit 3.2. Process gas which has been partially compressed in the first compression unit 3.1 flows through the intercooler 87 before entering the second compression unit 3.2. The temperature of the partially compressed process gas is thus reduced and the density thereof increased before the next compression step.

In the embodiment of FIG. 6 the intercooler 87 comprises two sections positioned in series along the flow path, namely a cooler 87.1 and a cooler 87.2. The cooler 87.1 can be a gas/air cooler, or a gas/water cooler, or the like and can be configured to bring the temperature of the process gas near to the ambient temperature. The cooler 87.2 can be configured to bring the temperature of the process gas below the ambient temperature. The cooling medium in the cooler 87.2 can be a heat transfer fluid of a coolant circuit 90 including a second heat transfer loop 91 where a coolant circulates. A circulation pump 93 can be provided to circulate the coolant in the second heat transfer loop 91. The second heat transfer loop 91 is adapted to remove heat from the partially compressed process gas and transfer said heat to the absorption refrigeration cycle 85.

In this embodiment, therefore, the waste heat generated by the fuel cell arrangement 29 is used to cool the process gas before and/or during the compression thereof, to increase the efficiency of the compressor 3 and reduce the power required to drive the compressor 3. The dimension of the compressor, and/or the number of stages thereof can also be reduced.

While in FIG. 6 a single intercooler is provided between two compression units, in other embodiments, not shown, a larger number of compression units and a larger number of intercoolers can be provided. One, some or all said intercoolers can be in heat exchange relationship with the absorption refrigeration cycle 85 through one or more heat transfer loops 91.

Exemplary embodiments have been disclosed above and illustrated in the accompanying drawings. It will be understood by those skilled in the art that various changes, omissions and additions may be made to that which is specifically disclosed herein without departing from the scope of the invention as defined in the following claims.

1. A compression system comprising:
a compressor comprising a sealing arrangement including at least one gas seal;
a gas leakage recovery line, adapted to recover process gas leakages from the at least one gas seal; and,
a fuel cell arrangement, fluidly coupled to the gas leakage recovery line; wherein the fuel cell arrangement is adapted to process the recovered process gas leakages and generate electric power therefrom.

2. The compression system of claim 1, wherein the sealing arrangement comprises a separation gas supply adapted to deliver a separation gas in the sealing arrangement; the fuel cell arrangement being adapted to process a blend comprising recovered process gas leakages and separation gas leakages from the sealing arrangement.

3. The compression system of claim 1, wherein in use the compressor processes a hydrogen-containing process gas; and wherein the hydrogen contained in the recovered process gas leakages is directly used as a fuel in the fuel cell arrangement.

4. The compression system of claim 1, further comprising a conversion unit, adapted to convert at least part of the recovered process gas leakages into a gaseous species adapted as a fuel for the fuel cell arrangement.

5. The compression system of claim 1, wherein the compressor comprises at least one of:
a dynamic compressor having a rotary shaft, wherein the sealing arrangement comprises at least one rotary gas seal around the rotary shaft; and
a reciprocating compressor having a reciprocating piston rod, wherein the sealing arrangement comprises a gas seal packing around said piston rod.

6. The compression system of claim 1, further comprising at least one of the following: a control unit adapted to detect a flowrate of gas leakages delivered to the fuel cell arrangement, an electric power detection unit adapted to detect the power generated by the fuel cell arrangement; and a fuel gas integration line adapted to deliver a controlled flow of process gas to the fuel cell arrangement.

7-8. (canceled)

9. The compression system of claim 1, further comprising a heat exchanger, adapted to recover heat generated by the fuel cell arrangement.

10. The compression system of claim 1, further comprising a booster compressor adapted to booster the pressure of the process gas leakages upstream of the fuel cell arrangement.

11. The compression system of claim 1, further comprising:
a cooler positioned along a flow path of process gas processed by the compressor; and
a heat transfer system, adapted to remove heat generated by the fuel cell arrangement and transfer said heat to an absorption refrigeration cycle;
wherein the absorption refrigeration cycle is adapted to cool the process gas flowing through the cooler.

12. (canceled)

13. The compression system of claim 11, wherein the compressor comprises at least a first compression unit and a second compression unit, arranged in series; and wherein the cooler is arranged between a discharge side of the first compression unit and a suction side of the second compression unit.

14. (canceled)

15. A method of operating a gas compression system; the method comprising the following steps:
compressing a process gas in a compressor comprising a sealing arrangement;
recovering process gas leakages from the sealing arrangement;
delivering the recovered process gas leakages towards a fuel cell arrangement; and
in the fuel cell arrangement, processing the recovered process gas leakages and generating electric power therefrom.

16. The method of claim 15, wherein the process gas contains hydrogen.

17. The method of claim 15, further comprising the following steps:
delivering a separation gas to the sealing arrangement;
recovering a blend of process gas and separation gas leaking from the sealing arrangement;
flowing the blend through the fuel cell arrangement.

18. The method of claim 15 further comprising the step of converting at least part of the process gas leakages from the sealing arrangement into a different a gaseous species adapted as a fuel for the fuel cell arrangement.

19. The method of claim 18, wherein the process gas contains a hydrocarbon and said step of converting the process gas comprises a step of producing hydrogen from the hydrocarbon.

20. The method of claim 15, further comprising the following steps:
detecting the amount of gas leakages delivered to the fuel cell arrangement;
diverting additional process gas from the compressor, or from a line fluidly coupled to the compressor, and delivering said additional process gas to the fuel cell arrangement.

21. The method of claim 15 further comprising the following steps: recovering waste heat from the fuel cell arrangement; and using the recovered waste heat in an absorption refrigeration cycle and cooling the process gas therewith.

22. (canceled)

23. The method of claim 22, wherein the process gas is cooled in an intercooler arranged between a first compression unit and a second compression unit.
